(19) United States
(12) Patent Application Publication
(10) Pub. No.: US 2026/0166426 A1
(43) Pub. Date: Jun. 18, 2026

(54) GAME SYSTEM AND GAME ASSISTANCE METHOD

(71) Applicant: Nuvoton Technology Corporation, Hsinchu Science Park (TW)

(72) Inventors: Chang-Hong LIN, Taichung City (TW); Chieh-Sheng TU, Hsinchu Science Park (TW)

(21) Appl. No.: 19/299,760

(22) Filed: Aug. 14, 2025

(30) Foreign Application Priority Data
Dec. 13, 2024 (TW) 113148530

(51) Int. Cl. A63F 13/53; A63F 13/67; A63F 13/837

(52) U.S. Cl. CPC A63F 13/53; A63F 13/67; A63F 13/837

(57) ABSTRACT

A game system is provided. The game system includes a display device, an input device, a processing device, and a microcontroller. The display device is configured to display a first game screen. The input device is configured to receive a game operation. The processing device is configured to generate a second game screen based on the first game screen and the game operation. The microcontroller is connected to the processing device, the display device, and the input device. The microcontroller is configured to generate a game suggestion based on the first game screen and the game operation through the artificial intelligence (AI) module. The display device is further configured to display a third game screen including the second game screen and the game suggestion. The game suggestion is superimposed on the second game screen.

### CROSS REFERENCE TO RELATED APPLICATIONS

This Application claims priority of Taiwan Patent Application No.113148530, filed on Dec. 13, 2024, the entirety of which is incorporated by reference herein.

### BACKGROUND OF THE INVENTION

### Field of the Invention

The present invention relates to video games, and, in particular, to an application of artificial intelligence (AI) technology in video games.

### Description of the Related Art

AlphaStar is an AI system developed by DeepMind to challenge humans in the real-time strategy game StarCraft II. Starcraft II is a game that relies heavily on the player's strategic planning and reaction speed, and players must quickly strategize for managing resources, building bases, training troops, and more. Through Deep Learning (DL) and Reinforcement Learning (RL) technology, AlphaStar has been able to win 5-0 against the pro gamers. This shows that AI technology has the ability to handle long-term planning, complex strategies and immediate reactions.

Games hold key attractions for human players, such as innovative gameplay, challenge, and immersion, which keep them engaged. However, some challenges in games are not easily overcome by casual players. They require specialized skills or years of gaming experience to achieve good results. This makes it difficult for casual players to experience a sense of accomplishment, which can easily lead to player attrition.

Therefore, there is a need for a game system and a game assistance method that can apply AI technology to solve the above problems.

### BRIEF SUMMARY OF THE INVENTION

The present invention provides a game system comprising a display device, an input device, a processing device, and a microcontroller. The display device is configured to display a first game screen. The input device is configured to receive a game operation. The processing device is configured to generate a second game screen based on the first game screen and the game operation. The microcontroller is connected to the processing device, the display device, and the input device. The microcontroller is configured to generate a game suggestion based on the first game screen and the first game operation through an artificial intelligence module. The display device is also configured to display a third game screen comprising the second game screen and the game suggestion. The game suggestion is superimposed on the second game screen.

An embodiment of the present invention provides a game system comprising a display device, an input device, a processing device, and a microcontroller. The display device is configured to display a first game screen. The input device is configured to receive a first game operation. The microcontroller is connected to the processing device, the display device, and the input device. The microcontroller is configured to correct the first game operation to a second game operation based on the first game screen and the first game operation through an artificial intelligence module. The processing device is configured to generate a second game screen based on the first game screen and the second game operation. The display device is further configured to display the second game screen.

An embodiment of the present invention provides a game assistance method to be performed on a computer system. A computer system comprises a display device, an input device, a processing device, and a microcontroller. The microcontroller is connected to the processing device, the display device, and the input device. The game assistance method comprises the following operations. A first game screen is displayed on the display device. The input device receives a game operation. The processing device generates a second game screen based on the first game screen and the game operation. The microcontroller generates a game suggestion based on the first game screen and the first game operation through an artificial intelligence module. The display device displays a third game screen comprising the second game screen and the game suggestion, wherein the game suggestion is superimposed on the second game screen.

An embodiment of the present invention provides a game assistance method to be performed on a computer system. A computer system comprises a display device, an input device, a processing device, and a microcontroller. The microcontroller is connected to the processing device, the display device, and the input device. The game assistance method comprises the following steps. A first game screen is displayed on the display device. The input device receives a first game operation. The microcontroller corrects the first game operation to a second game operation based on the first game screen and the first game operation through an artificial intelligence module. The processing device generates a second game screen based on the first game screen and the second game operation. The display device displays the second game screen.

The game system and game assistance methods provided in this disclosure use AI technology to assist players in the game. Furthermore, AI technology analyzes game screens and players'game operations, provides player suggestions, or proactively corrects player mistakes. In this way, the barrier to entry for the game can be lowered, which can increase player loyalty to the game and attract more players to join.

### BRIEF DESCRIPTION OF THE DRAWINGS

This disclosure will be better understood from the description of the following exemplary embodiments with the accompanying drawings. In addition, it should be understood that in the flowchart of this disclosure, the order in which blocks are executed may be changed, and/or certain blocks may be changed, deleted or merged.

FIG. 1 is a system architecture diagram of a game system according to one of the embodiments of the present invention;

FIG. 2 is a data flow diagram of a game assistance method according to one of the embodiments of the present invention;

FIG. 3 is a data flow diagram of a game assistance method according to one of the embodiments of the present invention; and

FIG. 4 is a data flow diagram of a game assistance method according to one of the embodiments of the present invention.

### DETAILED DESCRIPTION OF THE INVENTION

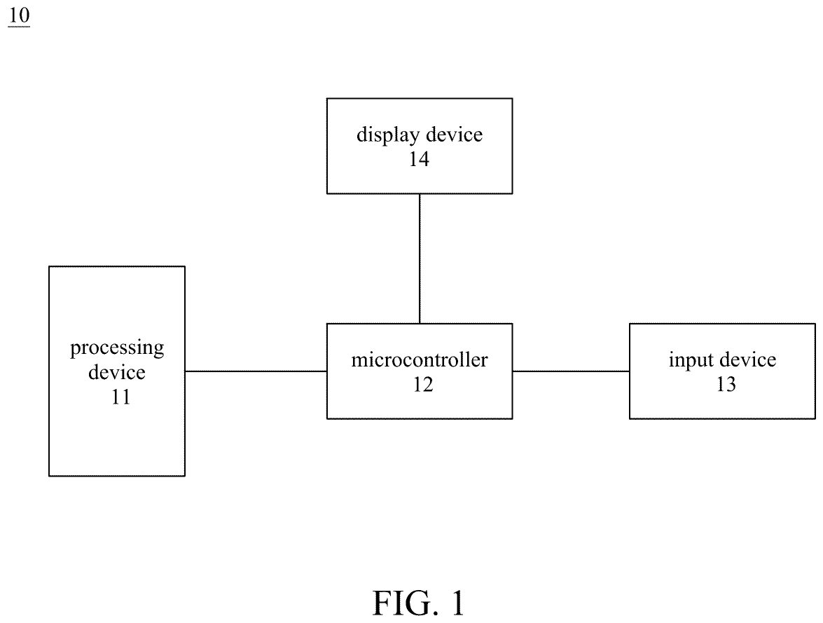

FIG. 1 is a system architecture diagram of a game system 10 according to one of the embodiments of the present invention. As shown in FIG. 1, the game system 10 comprises a processing device 11, a microcontroller 12, an input device 13 and a display device 14, and the microcontroller 12 is connected to the processing device 11, the input device 13 and the display device 14.

The gaming system 10 may be a computer system or processing device with computational capabilities, such as personal computers (e.g., desktop computers or laptops), server computers, or mobile devices (e.g., tablets or smartphones), but the disclosure is not limited thereto.

The processing device 11 may contain any one or more general-purpose or specialized processors used to execute instructions, and combinations thereof, such as central processing units (CPUs) and/or graphics processing units (GPUs) ° The processing device 11 may further comprise dynamic random access memories (DRAMs) and/or static random access memories (SRAMs) and other volatile memories, but the disclosure is not limited thereto.

The microcontroller 12 may be any single-chip microcomputer system with computational capabilities, such as the Arduino, ESP32, STM32, or PIC series, etc., but the disclosure is not limited thereto.

The input device 13 may be any kind of devices capable of receiving input commands from users, such as keyboards, mouses, gaming handlebars, touch screens, microphones or cameras, etc., but the disclosure is not limited thereto.

The display devices 14 may be any kind of displays, such as computers/TVs/mobile phones/tablet screens, e-paper displays, or head-mounted display devices, but the disclosure is not limited thereto.

In one of the embodiments, the display device 14 may comprise a microcontroller 12. In other words, the microcontroller 12 can be built into the display device 14. In another embodiment, the microcontroller 12 can be independently connected to the processing device 11, the input device 13 and the display device 14 to support various display devices.

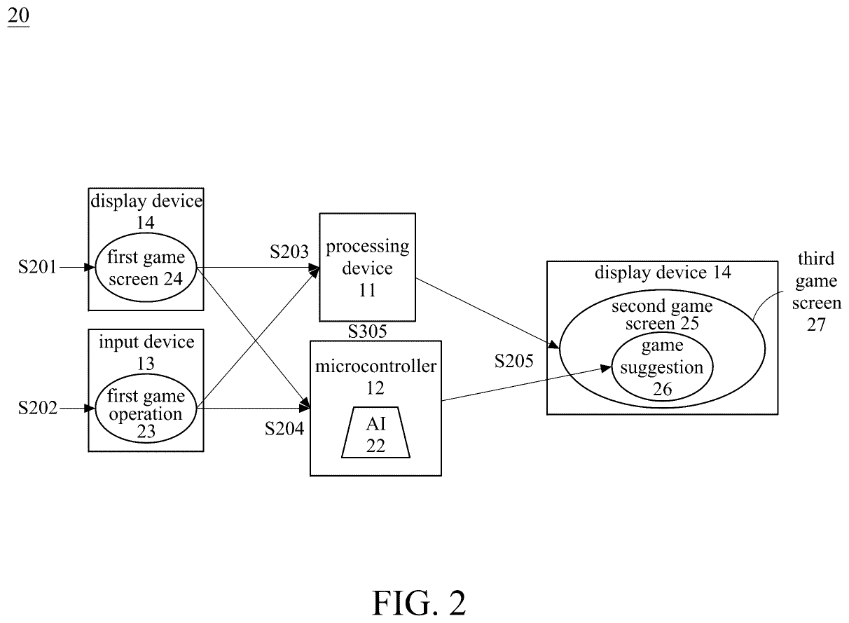

FIG. 2 is a data flow diagram of a game assistance method 20 according to one of the embodiments of the present invention, and the game assistance method 20 is implemented in the game system 10 of FIG. 1. As shown in FIG. 2, the game assistance method 20 comprises S201˜S205. The following describes steps S201˜S205 of game assistance method 20.

In step S201, the display device 14 displays a first game screen 24. The first game screen 24 may contain any visual representation of the game, such as a game scene, a character (or a “hero”), a user interface (UI), game perspectives, animations, special effects, etc., but the disclosure is not limited thereto. The user interface is used to provide key information about the player's game, such as health, taskbar, resource bar, score, level, etc., which can be presented in the form of any interactive interfaces, such as game menus, dialogs, buttons, etc., but the disclosure is not limited thereto.

In step S202, the input device 13 receives a first game operation 23. The first game operation 23 is the player's reaction on the input device 13 based on the first game screen 24, such as a keyboard or the keying operations of a game handle, the cursor of a mouse, etc., which can be used to, for example, control the movements of the game characters, cast skills, switch props, lock targets, etc., but the disclosure is not limited thereto.

In step S203, the processing device 11 generates a second game screen 25 based on the first game screen 24 and the first game operation 23. The second game screen 25 is the result of the frame changes caused by the player performing the first game operation 23 on the basis of the first game screen 24. For example, if a player performs a move, attack, or interaction in response to the first game screen 24, the second game screen 25 will show an update to the game environment or character state triggered by that operation, reflecting the impact of the player's actions on the game scenario.

In step S204, the microcontroller 12 generates a game suggestion 26 based on the first game screen 24 and the first game operation 23 through an artificial intelligence module (AI) 22.

The game suggestion 26 is arranged to instruct the player on how to play. In one of the embodiments, the game suggestion 26 contains explanatory text, a marking guideline, an action demonstration, or a combination thereof. The explanatory text is presented in the form of a textual narrative, the marking guideline is presented in the form of images (e.g. symbols, patterns), and the action demonstration is presented in animation. For example, if the game suggestion 26 instructs the player to move to the right, the explanatory text can be “press the right button”, the marking guideline can be an arrow icon of “right”, and the action demonstration can be “an animation of the game character moving to the right”. In other embodiments, with the expansion of the output device (e.g., audio system) of the game system 10, the game suggestion 26 may also include any way that can remind the player with the five senses, such as sound prompt, vibration prompt, etc., but the disclosure is not limited thereto.

The artificial intelligence module (AI) 22 contains at least one AI model. In one of the embodiments, an artificial intelligence module (AI) 22 comprises at least one regression model that outputs one or more sets of vectors or coordinates. The microcontroller 12 can then generate the game suggestion 26 based on the output vectors or coordinates, such as generating a selection area for spells or skills to cast based on multiple sets of coordinates output, or generating arrow symbols based on the output vectors to indicate the hero's suggested movement direction, etc., but the disclosure is not limited thereto.

It should be noted that this disclosure does not limit the number of groups and dimensions of the coordinates output by the artificial intelligence module (AI) 22, as well as the number of groups and dimensions of vectors, nor the state of the regression model used. The regression model can be based on Support Vector Regression (SVR), Decision Tree Regression, Neural Network (NN) Regression.

In addition, this disclosure does not limit the training method of the regression model used in the artificial intelligence module (AI) 22. In one of the embodiments, the regression model is performed through reinforcement learning (RL) to self-play. In one of the embodiments, the regression model relies on the training data provided by professional players for supervised machine learning. In an implementation aspect, a background program can be run to record the game screen and its operations, such as the coordinates of skill casting, to generate training data while a professional player is playing.

In one of the embodiments, in addition to generating the game suggestion 26 based on the first game screen 24 and the first game operation 23, the microcontroller 12 generates the game suggestion 26 through the artificial intelligence module (AI) 22. Game progress refers to the player's development in the game, involving such as the development of the story, the improvement of the character's skills or abilities, the completion of the level, etc., but this disclosure is not limited thereto. Specifically, the optimal strategy for game controls may change depending on the game's progression. For example, if the level or strength of the hero is relatively high on the same game screen, it is advisable to adopt a more aggressive strategy; Conversely, if the hero's level or strength is relatively low, it is advisable to adopt a more conservative strategy. Therefore, in addition to the current game screen, the microcontroller 12 can also take the game progress into account when generating game suggestions.

In one of the embodiments, the microcontroller 12 generates the game suggestion 26 based on a series of game screens and the first game operation 23 through an artificial intelligence module (AI) 22, and the series of game screens comprises the first game screen 24. In other words, in addition to the first game screen 24, the microcontroller 12 can also refer to other game screens displayed before the first game screen 24, and may include the previous game screen, the two game screens before etc., to generate the game suggestion 26, but the disclosure is not limited thereto. It is worth noting that by referencing a series of game screens, it is helpful for artificial intelligence modules (AIs) 22 to detect changing trends, such as the movement of the gun's crosshairs, and to draw more reliable inferences (i.e. game suggestion 26).

Although the present disclosure describes the processing device 11 and the microcontroller 12 in steps S203 and S204 respectively, the order of the two is interchangeable. In other words, this disclosure does not limit the order in which the processing device 11 and the microcontroller 12 are made. In one of the embodiments, step S203 and step S204 may even be performed at the same time. In other words, the processing device 11 generates a second game screen 25 based on the first game screen 24 and the first game operation 23. At the same time, the microcontroller 12 generates the game suggestion 26 based on the first game screen 24 and the first game operation 23 through the artificial intelligence module (AI) 22.

In step S205, display device 14 displays a third game screen 27. In detail, if the third game screen 27 contains the second game screen 25 and the game suggestion 26, the game suggestion 26 is superimposed on the second game screen 25.

It is important to note that the arrows in FIG. 2 are only used to describe the direction of data flow and do not represent the connection between components. With reference to the FIG. 1, the data transmission between the processing device 11, the display device 14, and the input device 13 can all pass through the microcontroller 12. In other words, the game assistance method 20 may be more involved in the data transfer operation performed by the microcontroller 12.

In addition, this disclosure does not limit the game suggestion 26 to be superimposed on the second game screen 25 by the display device 14. In one of the embodiments, the display device 14 receives the second game screen 25 from the processing device 11, and after receiving the game suggestion 26 from the microcontroller 12, the game suggestion 26 is superimposed on top of the second game screen 25 to generate the third game screen 27. In another embodiment, the microcontroller 12 superimposes the game suggestion 26 on top of the second game screen 25 to generate the third game screen 27. Next, the display device 14 receives and displays the third game screen 27.

The following is based on a Real Time Strategy (RTS) game Age of Empires II as an example to illustrate the step S204 of method 20.

In Age of Empires II, walling is designed to deter enemy attacks or restrict the movement of enemy troops by building walls. However, the wall built by the player may be breached due to the terrain or the player's negligence, leaving the player vulnerable to enemy attacks. Therefore, based on the gap in the wall in the first game screen 24, the map and the first game operation 23, the game suggestion 26 generated by the microcontroller 12 through the artificial intelligence module (AI) 22 may include a notch marking pattern. Alternatively, based on the enemy's actions in the first game screen 24, the game suggestion 26 generated by the microcontroller 12 through the artificial intelligence module (AI) 22 may contain a text or a pattern indicating the enemy's potential attack routes.

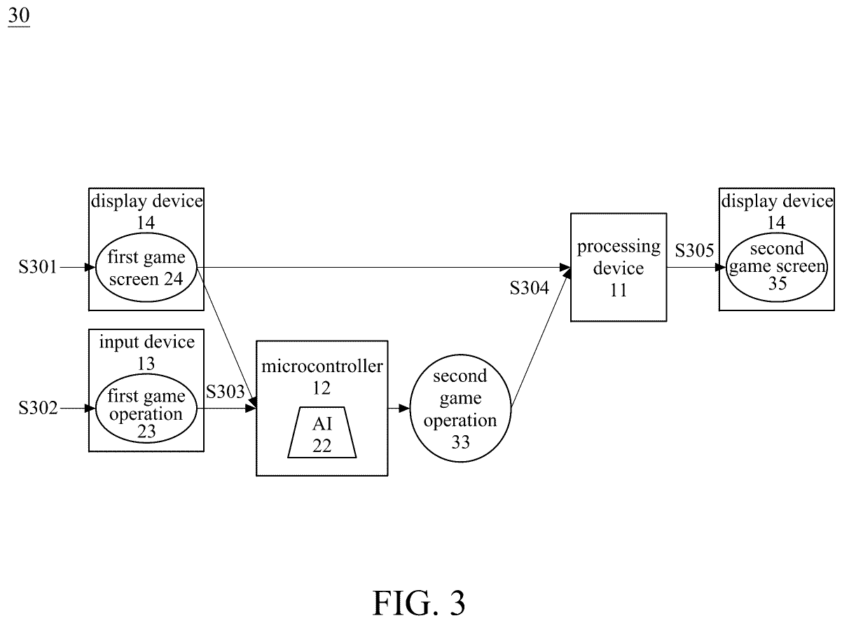

FIG. 3 is a data flow diagram of the game assistance method 30 according to one of the embodiments of the present invention, and the game assistance method 30 is realized in the game system 10 of FIG. 1. As shown in FIG. 3, the game assistance method 30 comprises steps S301˜S305, wherein step S301 is the same as step S201 in FIG. 2, and step S302 is the same as step S202, so it is not repeated herein. The following describes steps S303˜S305 of the game assistance method 30.

In step S303, the microcontroller 12 modifies the first game operation 23 to the second game operation 33 through the artificial intelligence module (AI) 22 based on the first game screen 24 and the first game operation 23. Similar to the first game operation 23, the second game operation 33 can be used for, for example, controlling the movements of game characters, casting skills, switching props, locking targets, etc., but the disclosure is not limited thereto. Specifically, the microcontroller 12 can correct the first game operation 23 according to the coordinates or vectors output by the regression model in the artificial intelligence module (AI) 22, such as correcting the right movement to the left according to the vectors of the output, or correcting the skill cast location according to the coordinates of the output, but this disclosure is not limited thereto.

In one of the embodiments, in addition to being based on the first game screen 24 and the first game operation 23, the microcontroller 12, through the artificial intelligence module (AI) 22, further based on the game process, corrected the first game operation 23 to the second game operation 33.

In one of the embodiments, the microcontroller 12 corrects the first game operation 23 to the second game operation 33 through the artificial intelligence module (AI) 22 based on a series of game screens and the first game operation 23, and the series of game screens comprises the first game screen 24. In other words, in addition to the first game screen 24, the microcontroller 12 can also refer to other game screens displayed before the first game screen 24, and may include the previous game screen, the two game screens before etc., to amend the game, but this disclosure is not limited thereto. It should be understood that by referring to a series of game screens, it is helpful for the artificial intelligence module (AI) 22 to detect the changing trends within, such as the direction of enemy movement, so as to derive more reliable inferences as the second game operation 33.

In step S304, the processing device 11 generates a second game screen 35 based on the first game screen 24 and the second game operation 33. In step S305, the display device 14 displays the second game screen 35.

It is important to note that the arrows in FIG. 3 are only used to describe the direction of data flow and do not represent the connection between components. With reference to the FIG. 1, the data transmission between the processing device 11, the display device 14, and the input device 13 can all pass through the microcontroller 12. In other words, the game assistance method 20 may be more involved in the data transfer operation performed by the microcontroller 12.

The following is a first-person shooter (FPS) game as an example to illustrate step S303 of method 30.

In a first-person shooter game, the simulated recoil of the gun causes the reticle to drift along a trajectory when firing continuously, making it impossible to shoot accurately. Generally speaking, in order to shoot accurately, the player must constantly correct the position of the crosshair when firing, commonly known as the “recoil control” technique. However, due to the different offset characteristics of different guns in the game, they will correspond to different “recoil control” skills, and the recoil control is not easy for casual players to master. Therefore, the microcontroller 12 can provide the player with correct recoil control processing to aim at the ideal crosshair position through an artificial intelligence module (AI) 22 based on the type of gun in the first game screen 24, the actual point of impact and the first game operation 23.

The following is based on Multiplayer Online Battle Arena (MOBA) League of Legends as an example to illustrate the step S303 of method 30.

In League of Legends, players need to cast skills to clear enemies quickly. However, it is possible that skill casting location deviated due to the player's negligence, causing the attack to be less effective than expected. Therefore, the microcontroller 12 can modify the first game operation 23 to the second game operation 33 through the artificial intelligence module (AI) 22, based on the enemy distribution location in the first game screen 24, the map and the first game operation 23, so that the skill casting location can be corrected to the attack range, which can cover the location of more enemies.

In one of the embodiments, the microcontroller 12 can be divided into two stages to assist the player. These two stages have different levels of AI involvement. Specifically, in the first stage, the microcontroller 12 can first generate the game suggestion 26 based on the first game screen 24 through the artificial intelligence module (AI) 22 to remind the player to implement a better game operation. In the second stage, the microcontroller 12 can then modify the first game operation 23 to the second game operation 33 based on the first game screen 24 and the first game operation 23 through an artificial intelligence module (AI) 22 to ensure that the player implements a better game operation.

For example, in League of Legends, the microcontroller 12 can use the artificial intelligence module (AI) 22 to indicate the ideal location for the skill casting on the screen based on the location of the enemies and the map in the first game screen 24. After the player casts the skill (i.e. the first game operation 23), the artificial intelligence module (AI) 22 is used to correct the player's skill casting location to an ideal location based on the first game operation 23, so as to cover more enemies.

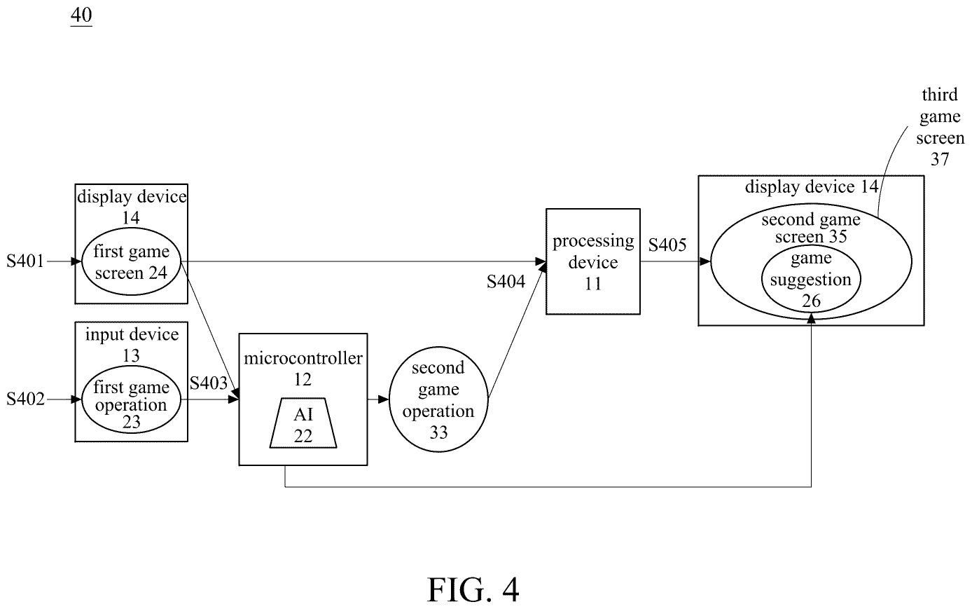

The FIG. 4 is a data flow diagram of a game assistance method 40 according to one of the embodiments of the present invention, and the game assistance method 40 is implemented in the game system 10 of the FIG. 1. Game assistance method 40 is only a combination of method 20 and method 30. In other words, with the help of the game 40, it is possible to provide the player's game suggestions while correcting the player's game operations.

As shown in the FIG. 4, the game assistance method 40 comprises steps S401˜S405, wherein step S401 is the same as step S201 and S301, step S402 is the same as step S202 and S302, and step S403 comprises steps S204 and S303, step S404 is the same as step S304, and step S405 is the same as step S205. Step S403 is explained below.

In step 403, the microcontroller 12 generates the game suggestion 26 based on the first game screen 24 and the first game operation 23 through the artificial intelligence module (AI) 22. At the same time, the microcontroller 12 modifies the first game operation 23 to the second game operation 33 based on the first game screen 24 and the first game operation 23 through the artificial intelligence module 22.

In one of the embodiments, the microcontroller 12 may obtain the game suggestion 26 through a first artificial intelligence model in the artificial intelligence module (AI) 22 and the second game operation 33 through a second artificial intelligence model in the artificial intelligence module (AI) 22. While both the two AI models in the artificial intelligence module (AI) 22 refer to the first game screen 24 and the first game operation 23, their reference weights to the first game screen 24 and the first game operation 23 can be different.

Taking the skill casting in League of Legends as an example, the microcontroller 12 can modify the first game operation 23 to the second game operation 33 through the second artificial intelligence model based on the enemy distribution location, map and the first game operation 23 in the first game screen 24, so as to correct the location of the skill casting to cover more enemies. On the other hand, the microcontroller 12 can determine the movement of distant enemies through the first artificial intelligence model, based on the map in the first game screen, and generate the game suggestion 26 to warn the player of potential attacks from distant enemies.

In one of the embodiments, the microcontroller 12 comprises a toggle for providing the player to set the degree to which the AI intervenes in the game. For example, in the first mode, the microcontroller 12 only provides the game suggestion 26 to players without directly interfering with the player's actual operation. In the second mode, the microcontroller 12 directly assists the player in correcting the first game operation 23 to the second game operation 33 without providing the game suggestion 26. In the third mode (which may be more suitable for beginners), the microcontroller 12 provides the game suggestion 26 and corrects the first game operation 23 to the second game operation 33.

The game system and game assistance methods provided in this disclosure use AI technology to assist players in the game. Furthermore, AI technology analyzes game screens and players'game operations, provides player suggestions, or proactively corrects player mistakes. In this way, the barrier to entry for the game can be lowered, which can increase player loyalty to the game and attract more players to join.

What is claimed is:

1. A game system comprising:
a display device, configured to display a first game screen;
an input device, configured to receive a first game operation;
a processing device, configured to generate a second game screen based on the first game screen and the first game operation; and
a microcontroller, connected to the processing device, the display device, and the input device, wherein the microcontroller is configured to generate a game suggestion based on the first game screen and the first game operation through an artificial intelligence module;
wherein the display device is further configured to display a third game screen comprising the second game screen and the game suggestion, and the game suggestion is superimposed on the second game screen.

2. The game system as claimed in claim 1, wherein the game suggestion includes explanatory text, a marking guideline, an action demonstration, or a combination thereof.

3. The game system as claimed in claim 1, wherein the display device includes the microcontroller.

4. A game system comprising:
a display device, configured to display a first game screen;
an input device, configured to receive a first game operation;
a processing device; and
a microcontroller, connected to the processing device, the display device, and the input device, wherein the microcontroller is configured to correct the first game operation to a second game operation through an artificial intelligence module based on the first game screen and the first game operation;
wherein the processing device is configured to generate a second game screen based on the first game screen and the second game operation;
wherein the display device is further configured to display the second game screen.

5. A game system as claimed in claim 4, wherein the display device includes the microcontroller.

6. A game assistance method, performed in a computer system comprising a display device, an input device, a processing device, and a microcontroller, wherein the microcontroller is connected to the processing device, the display device, and the input device, and the game assistance method comprises:
by the display device, displaying a first game screen;
by the input device, receiving a first game operation;
by the processing device, generating a second game screen based on the first game screen and the first game operation;
by the microcontroller, generating a game suggestion based on the first game screen and the first game operation through an artificial intelligence module; and
by the display device, displaying a third game screen comprising the second game screen and the game suggestion, wherein the game suggestion is superimposed on the second game screen.

7. The game assistance method as claimed in claim 6, further comprises using the microcontroller to generate the game suggestion based on the first game screen, the first game operation, and a game process through the artificial intelligence module.

8. The game assistance method as claimed in claim 6 further comprises using the microcontroller to generate the game suggestion based on a series of game screens and the first game operation through the artificial intelligence module, wherein the series of game screens includes the first game screen.

9. The game assistance method as claimed in claim 6 further comprises using the microcontroller to superimpose the game suggestion on top of the second game screen to generate the third game screen.
